(19) United States
(12) Patent Application Publication
(10) Pub. No.: US 2016/0017133 A1
(43) Pub. Date: Jan. 21, 2016

(54) TRANSLUCENT POLYOLEFIN FILM FOR PACKAGING APPLICATIONS

(71) Applicants: Rohm and Haas Company, Philadelphia, PA (US); Dow Global Technologies LLC, Midland, MI (US)

(72) Inventors: Xuming Chen, Katy, TX (US); Claudia Hernandez, Freeport, TX (US); Edward La Fleur, Holland, PA (US); Edwin Hugh Nungesser, Horsham, PA (US); Himal Ray, Collegeville, PA (US)

(21) Appl. No.: 14/775,765

(22) PCT Filed: Mar. 21, 2014
(86) PCT No.: PCT/US2014/031440

§ 371 Date: Sep. 14, 2015

Related U.S. Application Data
(60) Provisional application No. 61/804,894, filed on Mar. 25, 2013.

(51) Int. Cl. C08L 23/06; C08L 23/12

(52) U.S. Cl. CPC C08L 23/06; C08L 23/12

(57) ABSTRACT

A film comprising from 1 to 50 wt % of polymeric particles having: (a) an average particle diameter from 0.5 to 15 μm; (b) a refractive index from 1.46 to 1.7; and (c) at least 60% polymerized residues of acrylic monomers; and a continuous polymeric phase comprising a polyolefin; wherein an average refractive index difference measured from 400 nm to 800 nm between the polymeric particles and the continuous polymeric phase is at least 0.03.

This invention relates to a polyolefin film having enhanced opacity which is particularly useful for packaging applications.

There are a number of approaches to enhancing the opacity of polyolefin films, including addition of opaque high density inorganic fillers and pigments, creation of voids in the polyolefin and addition of light-diffusing polymers. For example, U.S. Pub. No. 2008/0050539 discloses a polyolefin film comprising light-diffusing polymers for this purpose. However, in this and other approaches, low levels of polymers are used because of increased opacity from scattering; high levels have a deleterious effect on the mechanical properties of the matrix polymer and there are inherent difficulties in dispersing high concentrations of polar particles into the non-polar polyolefin matrix.

The problem addressed by the present invention is to provide a polyolefin film having enhanced opacity which is particularly useful for packaging applications.

### STATEMENT OF INVENTION

The present invention provides a film comprising from 1 to 50 wt % of polymeric particles having: (a) an average particle diameter from 0.5 to 15 μm; (b) a refractive index from 1.46 to 1.7; and (c) at least 60% polymerized residues of acrylic monomers; and a continuous polymeric phase comprising a polyolefin; wherein an average refractive index difference measured from 400 nm to 800 nm between the polymeric particles and the continuous polymeric phase is at least 0.03.

### DETAILED DESCRIPTION

Percentages are weight percentages (wt %) and temperatures are in ° C., unless specified otherwise. Refractive index (RI) values are determined at the sodium D line, where λ=589.29 nm at 20° C., unless specified otherwise. Polymeric particles comprise organic polymers, preferably addition polymers, and preferably are substantially spherical. Average particle diameter is determined as the arithmetic mean particle diameter. T_{g} values are calculated from homopolymer T_{g} values using the Fox equation; see Bulletin of the American Physical Society 1, 3, page 123 (1956). The T_{g} of a polymeric particle whose composition varies throughout the particle is the weight average of the T_{g} values of the different compositions in the particle. Weight percentages of monomers are calculated for each stage of a multistage polymer based on the total weight of monomers added to the polymerization mixture in that stage. As used herein the term “(meth)acrylic” refers to acrylic or methacrylic, and “(meth)acrylate” refers to acrylate or methacrylate. The term “(meth)acrylamide” refers to acrylamide (AM) or methacrylamide (MAM). “Acrylic monomers” include acrylic acid (AA), methacrylic acid (MAA), esters of AA and MAA, itaconic acid (IA), crotonic acid (CA), acrylamide (AM), methacrylamide (MAM), and derivatives of AM and MAM, e.g., alkyl (meth)acrylamides. Esters of AA and MAA include, but are not limited to, alkyl, hydroxyalkyl, phosphoalkyl and sulfoalkyl esters, e.g., methyl methacrylate (MMA), ethyl methacrylate (EMA), butyl methacrylate (BMA), hydroxyethyl methacrylate (HEMA), hydroxyethyl acrylate (HEA), hydroxypropyl methacrylate (HPMA), hydroxybutyl acrylate (HBA), methyl acrylate (MA), ethyl acrylate (EA), butyl acrylate (BA), 2-ethylhexyl acrylate (EHA), cyclohexyl methacrylate (CHMA), benzyl acrylate (BzA) and phosphoalkyl methacrylates (e.g., PEM). “Styrenic monomers” include styrene, α-methylstyrene; 2-, 3-, or 4-alkylstyrenes, including methyl- and ethyl-styrenes; preferably styrene.

The term “vinyl monomers” refers to monomers that contain a carbon-carbon double bond that is connected to a heteroatom such as nitrogen or oxygen. Examples of vinyl monomers include, but are not limited to, vinyl acetate, vinyl formamide, vinyl acetamide, vinyl pyrrolidone, vinyl caprolactam, and long chain vinyl alkanoates such as vinyl neodecanoate, and vinyl stearate. The term “polyolefins” refers to polymers or copolymers of alkenes, preferably those having from two to ten carbon atoms, preferably two to eight carbon atoms, preferably two to four carbon atoms, preferably propylene or ethylene. Preferably, the continuous polymeric phase comprises at least 75 wt % polyolefin, preferably at least 85 wt %, preferably at least 95 wt %, preferably at least 98 wt %. Preferred polyolefins include copolymers of alkenes, especially of ethylene with other alkenes, preferably those having from three to eight carbon atoms; preferably the other alkenes are present in a total amount from 0-90 wt %, preferably 2-50 wt %, preferably 3-40 wt %. Preferably, weight-average molecular weight of the polyolefin is from 50,000 to 500,000, preferably from 70,000 to 300,000. Examples of polyolefins include the following:

| | | | | comonmer | |
|---|---|---|---|---|---|
| | | | | amount, | Mw, |
| Resin | MI | Density | Comonomer | wt % | g/mol |
| AFFINITY 1880 | 1.00 | 0.890 | Octene | 18 | 104100 |
| INFUSE 9100 | 1.00 | 0.877 | Octene | 31 | 123800 |
| DOWLEX 2045 | 1.00 | 0.920 | Octene | 10 | 119,000 |
| DOWLEX 2027 | 6.80 | 0.941 | Octene | 3 | 90,000 |

The polymeric particles have an average particle diameter no less than 0.5 μm due to the difficulty of dispersing such small particles. Preferably, the polymeric particles have an average particle diameter of at least 0.7 μm, preferably at least 0.9 μm, preferably at least 1 μm, preferably at least 1.5 μm, preferably at least 2 μm, preferably at least 2.5 μm, preferably at least 3 μm, preferably at least 3.5 μm; preferably, these particles have an average particle diameter no greater than 12 μm, preferably no greater than 10 μm, preferably no greater than 8 μm, preferably no greater than 6 μm, preferably no greater than 5.5 μm. Preferably, the polymeric particles have a particle size distribution indicating a single mode; preferably the width of the particle size distribution at half-height is from 0.1 to 3 μm, preferably from 0.2 to 1.5 μm. The film may contain particles having different average diameters provided that particles of each average diameter have a particle size distribution as described immediately above. The particle size distribution is determined using a particle size analyzer.

Refractive index differences stated herein are absolute values. Preferably, the refractive index difference (i.e., the absolute value of the difference) measured from 800 nm to 2500 nm between the polymeric particle and the continuous polymeric phase is at least 0.06, preferably at least 0.08, preferably at least 0.09, preferably at least 0.1 Preferably, the refractive index difference measured from 800 nm to 2500 nm between the polymeric particle and the continuous polymeric phase is no greater than 0.2, preferably no greater than 0.17, preferably no greater than 0.15. Preferably, the refractive index difference measured from 400 nm to 800 nm between the polymeric particle and the continuous polymeric phase is at least 0.04, preferably at least 0.05, preferably at least 0.06, preferably at least 0.07, preferably at least 0.08. Preferably, the refractive index difference measured from 400 nm to 800 nm between the polymeric particle and the continuous polymeric phase is no greater than 0.2, preferably no greater than 0.15, preferably no greater than 0.1. Preferably, the refractive index of the polymeric particle is from 1.51 to 1.7 preferably from 1.52 to 1.68, preferably from 1.53 to 1.65, preferably from 1.54 to 1.6. Preferably, the refractive index of the continuous polymeric phase is from 1.4 to 1.6, preferably from 1.45 to 1.55, preferably from 1.47 to 1.53, preferably from 1.48 to 1.52. Preferably, the refractive index of the polymeric particle is greater than the refractive index of the continuous polymeric phase in the infrared region, i.e., from 800-2500 nm.

Preferably, the polymeric particle in the film is one having a radial refractive index gradient (“GRIN” particle, see, e.g., US 20090097123). Preferably, GRIN particles have a refractive index which increases continuously from the center of the particles to the surface. Preferably, GRIN particles have a refractive index at the surface from 1.51 to 1.7 preferably from 1.52 to 1.68, preferably from 1.53 to 1.65, preferably from 1.54 to 1.6; and a refractive index at the center from 1.45 to 1.53, preferably from 1.46 to 1.52, preferably from 1.47 to 1.51. GRIN particles may have a core derived from a polymer seed used to produce the GRIN particle. Preferably, the core of the GRIN particle is no more than 95 wt % of the particle, preferably no more than 80 wt %, preferably no more than 60 wt %, preferably no more than 40 wt % preferably no more than 20 wt %. The refractive index of a GRIN particle for purposes of calculating a refractive index difference is the refractive index at the particle surface.

Preferably, the continuous polymeric phase comprises from 2 to 45 wt % of the polymeric particles, based on the weight of the entire film; preferably at least 3 wt %, preferably at least 4 wt %, preferably at least 5 wt %, preferably at least 10 wt %; preferably no more than 40 wt %, preferably no more than 30 wt %, preferably no more than 20 wt %, preferably no more than 15 wt %, preferably no more than 10 wt %. The continuous polymeric phase is continuous in the sense that there is an unbroken path connecting all parts of the polymer.

Preferably, the polymeric particles comprise at least 65% polymerized residues of acrylic monomers, preferably at least 70%, preferably at least 75%, preferably at least 80%. Preferably, the polymeric particles comprise at least 70% polymerized residues of acrylic and styrenic monomers, preferably at least 80%, preferably at least 90%, preferably at least 95%, preferably at least 97%. Preferably, the polymeric particle also comprises 0 to 5% polymerized residues of acid monomers (e.g., AA, MAA, IA, CA), preferably 0.5 to 4% AA and/or MAA, and may also contain small amounts of residues of vinyl monomers.

Crosslinkers are monomers having two or more ethylenically unsaturated groups, or coupling agents (e.g., silanes) or ionic crosslinkers (e.g., metal oxides). Crosslinkers having two or more ethylenically unsaturated groups may include, e.g., divinylaromatic compounds, di-, tri- and tetra-(meth)acrylate esters, di-, tri- and tetra-allyl ether or ester compounds and allyl (meth)acrylate. Preferred examples of such monomers include divinylbenzene (DVB), trimethylolpropane diallyl ether, tetraallyl pentaerythritol, triallyl pentaerythritol, diallyl pentaerythritol, diallyl phthalate, diallyl maleate, triallyl cyanurate, Bisphenol A diallyl ether, allyl sucroses, methylene bisacrylamide, trimethylolpropane triacrylate, allyl methacrylate (ALMA), ethylene glycol dimethacrylate (EGDMA), hexane-1,6-diol diacrylate (HDDA) and butylene glycol dimethacrylate (BGDMA). Preferably, the amount of polymerized crosslinker residue in the polymeric particle is no more than 10%, preferably no more than 9%, preferably no more than 8%, preferably no more than 7%, preferably no more than 6%; preferably at least 0.1%, preferably at least 0.5%, preferably at least 1%, preferably at least 2%, preferably at least 3%. Preferably, if crosslinkers are present, they have a molecular weight from 100 to 250, preferably from 110 to 230, preferably from 110 to 200, preferably from 115 to 160. Preferably, crosslinkers are difunctional or trifunctional, i.e., they are diethylenically or triethylenically unsaturated, respectively, preferably difunctional.

Preferably, the film comprising polymeric particles of the present invention is produced by extruding a mixture of the polyolefin and the polymeric particles. Preferably, the film is substantially free of inorganic fillers, i.e., it contains less than 5 wt % inorganic fillers, preferably less than 2 wt %, preferably less than 1 wt %, preferably less than 0.5 wt %, preferably less than 0.2 wt %. Preferably, a dispersant is added to aid in dispersing the particles, preferably in an amount from 0.1 wt % to 15 wt %, based on the entire film, preferably at least 0.5 wt %, preferably at least 1 wt %; preferably no more than 15 wt %, preferably no more than 12 wt %, preferably no more than 10 wt %, preferably no more than 8 wt %, preferably no more than 6 wt %. Preferably, the dispersant is an polyolefin-acrylic copolymer, preferably one having from 60 to 95 wt % polyolefin units and 5 to 40 wt % acrylic monomer units, preferably 70 to 90 wt % polyolefin and 10 to 30 wt % acrylic. Preferably, the acrylic monomers are esters of AA or MAA, preferably one- to twelve-carbon alkyl esters, preferably two- to eight-carbon esters of AA.

Preferably, the polymeric particles are prepared in an aqueous medium by known emulsion polymerization techniques, followed by spray drying of the resulting polymer latex. Spray drying typically results in clumps of polymeric particles having an average diameter of 1 to 15 μm. Preferably, these clumps are dispersed directly, without size reduction, into a polymer comprising a polyolefin to produce the film by a melt compounding process in an extruder, preferably at an extrusion temperature from 190 to 250° C., preferably from 195 to 240° C., preferably from 200 to 230° C.

### EXAMPLES

### Comparative Example 1

Film samples were prepared by melt extrusion blown process from pellets of the neat polymer resin. DOWLEX 2045G resin (Dow Chemical polyolefin) was melt processed in a Leistritz extruder (Twin screw, 38 mm extruder) at barrel temperature ranging from 190 to 225° C. The melt and extrusion process produced uniform polymer melt in the form of filaments which were quenched in a water bath. The melt extrusion was followed by pelletization and drying with an air knife. Additional drying of the pellets was later carried out at 60° C. in a vacuum oven, before extrusion blowing into thin film using a single screw extruder at barrel temperatures that ranged from 200 to 210° C. The film samples obtained were: 0.06 to 0.09 mm in thickness. These film samples were evaluated by, ASTM D882 (Standard test method for Tensile properties. ASTM D 10003-00 (Standard test method for haze and luminous transmittance of transparent plastics) and ASTM E 313-00 (Standard practice for calculating yellowness and whiteness indices from instrumentally measured color coordinates). The films described below were evaluated for diffuse light transmission (Tt) and yellowness index (YI), Tt was measured in accordance with ASTM D 10003-00. Yellowness index values were determined by ASTM E 313-00. Both dynamic and static coefficient of friction were measured on a universal machine (Instron 5564) under the conditions and specifications of the ASTM 1894-06 test method. The melt index (MI), of the samples, were also quantified under ASTM D-1238. The data are given in TABLEs II, III and IV below.

### Comparative Example 2

Film samples were prepared by melt extrusion blown process from pellets of the neat polymer resin. DOWLEX 2027 G resin (Dow Chemical polyolefin) was melt processed in a Leistritz extruder (Twin screw, 38 mm extruder) at barrel temperature ranging from 190 to 225° C. The melt and extrusion process produced uniform polymer melt in the form of filaments which were quenched in a water bath. The melt extrusion was followed by pelletization and drying with an air knife. Additional drying of the pellets was later carried out at 60° C. in a vacuum oven, before extrusion blowing into thin film using a single screw extruder at barrel temperatures that ranged from 200 to 210° C. The film samples obtained were: 0.06 to 0.09 mm in thickness. These film samples were evaluated by, ASTM D882 (Standard test method for Tensile properties). ASTM D 10003-00 (Standard test method for haze and luminous transmittance of transparent plastics) and ASTM E 313-00 (Standard practice for calculating yellowness and whiteness indices from instrumentally measured color coordinates). The films described below were evaluated for diffuse light transmission (Tt) and yellowness index (YI), Tt was measured in accordance with ASTM D 10003-00. Yellowness index values were determined by ASTM E 313-00. Both dynamic and static coefficient of friction were measured on a universal machine (Instron 5564) under the conditions and specifications of the ASTM 1894-06 test method. The melt index (MI), of the samples, were also quantified under ASTM D-1238. The data are given in TABLEs II, III and IV below.

### Comparative Example 3

Film samples were prepared by melt extrusion blown process from pellets of the neat polymer resin. XHS-7091 gas phase LLDPE resin (Dow Chemical polyolefin) was melt processed in a Leistritz extruder (Twin screw, 38 mm extruder) at barrel temperature ranging from 190 to 225° C. The melt and extrusion process produced uniform polymer melt in the form of filaments which were quenched in a water bath. The melt extrusion was followed by pelletization and drying with an air knife. Additional drying of the pellets was later carried out at 60° C. in a vacuum oven, before extrusion blowing into thin film using a single screw extruder at barrel temperatures that ranged from 200 to 210° C. The film samples obtained were: 0.06 to 0.09 mm in thickness. These film samples were evaluated by, ASTM D882 (Standard test method for Tensile properties). ASTM D 10003-00 (Standard test method for haze and luminous transmittance of transparent plastics) and ASTM E 313-00 (Standard practice for calculating yellowness and whiteness indices from instrumentally measured color coordinates). The films described below were evaluated for diffuse light transmission (Tt) and yellowness index (YI), Tt was measured in accordance with ASTM D 10003-00. Yellowness index values were determined by ASTM E 313-00. Both dynamic and static coefficient of friction were measured on a universal machine (Instron 5564) under the conditions and specifications of the ASTM 1894-06 test method. The melt index (MI), of the samples, were also quantified under ASTM D-1238. The data are given in TABLEs II, III and IV below.

### Example 4

Acrylic powder particles, A, of the composition given in TABLE I, were dry blended with DOWLEX 2045 resin (MI=1.00, Mw=119 k and density 0.920) and AMPLIFY EA copolymer (92 wt % ethylene/18 wt % EA) in the weight ratio of: 40; 50 and 10 all in weight percent to yield a finely dispersed powder plus granulated resin mixture of particles. This was followed by melt compounding in a Leistritz extruder at barrel temperature ranging from 190 to 225° C. The melt compounding was followed by pelletization and drying, at 60° C. overnight in a vacuum oven. The dried pellets were melt processed on a single screw Killion extruder and blown into thin film at a barrel temperature of 390 F-375 F (199 to 191° C.) and a melt temperature of 400 F (204° C.) and die pressure of 1850 psi (13 MPa). The film samples obtained were: 0.06 to 0.09 mm in thickness. These film samples were evaluated by, ASTM D882 (Standard test method for Tensile properties). ASTM D 10003-00 (Standard test method for haze and luminous transmittance of transparent plastics) and ASTM E 313-00 (Standard practice for calculating yellowness and whiteness indices from instrumentally measured color coordinates). The films described below were evaluated for diffuse light transmission (Tt) and yellowness index (YI), Tt was measured in accordance with ASTM D 10003-00. Yellowness index values were determined by ASTM E 313-00. Both dynamic and static coefficient of friction were measured on a universal machine (Instron 5564) under the conditions and specifications of the ASTM 1894-06 test method. The melt index (MI), of the samples, were also quantified under ASTM D-1238. The data are given in TABLEs II, III and IV below.

### Example 5

Acrylic powder particles, B, of the composition given in TABLE I, were dry blended with DOWLEX 2045 resin (MI=1.00, Mw=119 k and density 0.920) and AMPLIFY EA copolymer in the weight ratio of: 40; 50 and 10 all in weight percent to yield a finely dispersed powder plus granulated resin mixture of particles. This was followed by melt compounding in a Leistritz extruder at barrel temperature ranging from 190 to 225° C. The melt compounding was followed by pelletization and drying, at 60° C. overnight in a vacuum oven. The dried pellets were melt processed on a single screw Killion extruder and blown into thin film at a barrel temperature ranging from, 390 F-375 F, and a melt temperature of 400 F and die pressure of 1850 psi (13 MPa). The film samples obtained were: 0.06 to 0.09 mm in thickness. These film samples were evaluated by, ASTM D882 (Standard test method for Tensile properties). ASTM D 10003-00 (Standard test method for haze and luminous transmittance of transparent plastics) and ASTM E 313-00 (Standard practice for calculating yellowness and whiteness indices from instrumentally measured color coordinates). The films described below were evaluated for diffuse light transmission (Tt) and yellowness index (YI), Tt was measured in accordance with ASTM D 10003-00. Yellowness index values were determined by ASTM E 313-00. Both dynamic and static coefficient of friction were measured on a universal machine (Instron 5564) under the conditions and specifications of the ASTM 1894-06 test method. The melt index (MI), of the samples, were also quantified under ASTM D-1238. The data are given in TABLEs II, III and IV below.

### Example 6

Acrylic powder particles, C, of the composition given in TABLE I, were dry blended with DOWLEX 2045 resin (MI=1.00, Mw=119 k and density 0.920) and AMPLIFY EA copolymer in the weight ratio (DOWLEX/C/AMPLIFY) of: 70; 20 and 10 all in weight percent to yield a finely dispersed powder plus granulated resin mixture of particles. This was followed by melt compounding in a Leistritz extruder at barrel temperature ranging from 190 to 225° C. The melt compounding was followed by pelletization and drying, at 60° C. overnight in a vacuum oven. The dried pellets were melt processed on a single screw Killion extruder and blown into thin film at a barrel temperature ranging from, 390 F-375 F (199 to 191° C.) and a melt temperature of 400 F (204° C.) and die pressure of 1850 psi (13 MPa). The film samples obtained were: 0.06 to 0.09 mm in thickness. These film samples were evaluated by, ASTM D882 (Standard test method for Tensile properties). ASTM D 10003-00 (Standard test method for haze and luminous transmittance of transparent plastics) and ASTM E 313-00 (Standard practice for calculating yellowness and whiteness indices from instrumentally measured color coordinates). The films described below were evaluated for diffuse light transmission (Tt) and yellowness index (YI), Tt was measured in accordance with ASTM D 10003-00. Yellowness index values were determined by ASTM E 313-00. Both dynamic and static coefficient of friction were measured on a universal machine (Instron 5564) under the conditions and specifications of the ASTM 1894-06 test method. The melt index (MI), of the samples, were also quantified under ASTM D-1238. The data are given in TABLEs II, III and IV below.

### Example 7

Acrylic powder particles, A, of the composition given in TABLE I, were dry blended with DOWLEX 2027 resin (MI=6.80, Mw=90 k and density 0.941) and AMPLIFY EA copolymer in the weight ratio of: 40; 50 and 10 all in weight percent to yield a finely dispersed powder plus granulated resin mixture of particles. This was followed by melt compounding in a Leistritz extruder at barrel temperature ranging from 190 to 225° C. The melt compounding was followed by pelletization and drying, at 60° C. overnight in a vacuum oven. The dried pellets were melt processed on a single screw Killion extruder and blown into thin film at a barrel temperature of 390 F-375 F (199 to 191° C.) and a melt temperature of 400 F (204° C.) and die pressure of 1850 psi (13 MPa). The film samples obtained were: 0.06 to 0.09 mm in thickness. These film samples were evaluated by, ASTM D882 (Standard test method for Tensile properties). ASTM D 10003-00 (Standard test method for haze and luminous transmittance of transparent plastics) and ASTM E 313-00 (Standard practice for calculating yellowness and whiteness indices from instrumentally measured color coordinates). The films described below were evaluated for diffuse light transmission (Tt) and yellowness index (YI), Tt was measured in accordance with ASTM D 10003-00. Yellowness index values were determined by ASTM E 313-00. Both dynamic and static coefficient of friction were measured on a universal machine (Instron 5564) under the conditions and specifications of the ASTM 1894-06 test method. The melt index (MI), of the samples, were also quantified under ASTM D-1238. The data are given in TABLEs II, III and IV below.

### Example 8

Acrylic powder particles, B, of the composition given in TABLE I, were dry blended with DOWLEX 2027 resin (MI=6.80, Mw=90 k and density 0.941) and AMPLIFY EA copolymer in the weight ratio of: 40; 50 and 10 all in weight percent to yield a finely dispersed powder plus granulated resin mixture of particles. This was followed by melt compounding in a Leistritz extruder at barrel temperature ranging from 190 to 225° C. The melt compounding was followed by pelletization and drying, at 60° C. overnight in a vacuum oven. The dried pellets were melt processed on a single screw Killion extruder and blown into thin film at a barrel temperature ranging from, 390 F-375 F (199 to 191° C.) and a melt temperature of 400 F (204° C.) and die pressure of 1850 psi (13 MPa). The film samples obtained were: 0.06 to 0.09 mm in thickness. These film samples were evaluated by, ASTM D882 (Standard test method for Tensile properties). ASTM D 10003-00 (Standard test method for haze and luminous transmittance of transparent plastics) and ASTM E 313-00 (Standard practice for calculating yellowness and whiteness indices from instrumentally measured color coordinates). The films described below were evaluated for diffuse light transmission (Tt) and yellowness index (YI), Tt was measured in accordance with ASTM D 10003-00. Yellowness index values were determined by ASTM E 313-00. Both dynamic and static coefficient of friction were measured on a universal machine (Instron 5564) under the conditions and specifications of the ASTM 1894-06 test method. The melt index (MI), of the samples, were also quantified under ASTM D-1238. The data are given in TABLEs II, III and IV below.

### Example 9

Acrylic powder particles, C, of the composition given in TABLE I, were dry blended with DOWLEX 2027 resin (MI=6.80, Mw=90 k and density 0.920) and AMPLIFY EA copolymer in the weight ratio (DOWLEX/C/AMPLIFY) of: 70; 20 and 10 all in weight percent to yield a finely dispersed powder plus granulated resin mixture of particles. This was followed by melt compounding in a Leistritz extruder at barrel temperature ranging from 190 to 225° C. The melt compounding was followed by pelletization and drying, at 60° C. overnight in a vacuum oven. The dried pellets were melt processed on a single screw Killion extruder and blown into thin film at a barrel temperature ranging from, 390 F-375 F (199 to 191° C.) and a melt temperature of 400 F (204° C.) and die pressure of 1850 psi (13 MPa). The film samples obtained were: 0.06 to 0.09 mm in thickness. These film samples were evaluated by, ASTM D882 (Standard test method for Tensile properties). ASTM D 10003-00 (Standard test method for haze and luminous transmittance of transparent plastics) and ASTM E 313-00 (Standard practice for calculating yellowness and whiteness indices from instrumentally measured color coordinates). The films described below were evaluated for diffuse light transmission (Tt) and yellowness index (YI), Tt was measured in accordance with ASTM D 10003-00. Yellowness index values were determined by ASTM E 313-00. Both dynamic and static coefficient of friction were measured on a universal machine (Instron 5564) under the conditions and specifications of the ASTM 1894-06 test method. The melt index (MI), of the samples, were also quantified under ASTM D-1238. The data are given in TABLEs II, III and IV below.

### Example 10

Acrylic powder particles, A, of the composition given in TABLE I, were dry blended with XHS-7091 gas phase LLDPE resin (MI=1.00, Mw=119 k and density 0.9245) and AMPLIFY EA copolymer in the weight ratio of: 40; 50 and 10 all in weight percent to yield a finely dispersed powder plus granulated resin mixture of particles. This was followed by melt compounding in a Leistritz extruder at barrel temperature ranging from 190 to 225° C. The melt compounding was followed by pelletization and drying, at 60° C. overnight in a vacuum oven. The dried pellets were melt processed on a single screw Killion extruder and blown into thin film at a barrel temperature of 390 F-375 F (199 to 191° C.) and a melt temperature of 400 F (204° C.) and die pressure of 1850 psi (13 MPa). The film samples obtained were: 0.06 to 0.09 mm in thickness. These film samples were evaluated by, ASTM D882 (Standard test method for Tensile properties). ASTM D 10003-00 (Standard test method for haze and luminous transmittance of transparent plastics) and ASTM E 313-00 (Standard practice for calculating yellowness and whiteness indices from instrumentally measured color coordinates). The films described below were evaluated for diffuse light transmission (Tt) and yellowness index (YI), Tt was measured in accordance with ASTM D 10003-00. Yellowness index values were determined by ASTM E 313-00. Both dynamic and static coefficient of friction were measured on a universal machine (Instron 5564) under the conditions and specifications of the ASTM 1894-06 test method. The melt index (MI), of the samples, were also quantified under ASTM D-1238. The data are given in TABLEs II, III and IV below.

### Example 11

Acrylic powder particles, B, of the composition given in TABLE I, were dry blended with XHS-7091 gas phase LLDPE resin (MI=1.00, Mw=119 k and density 0.9245) and AMPLIFY EA copolymer in the weight ratio of: 40; 50 and 10 all in weight percent to yield a finely dispersed powder plus granulated resin mixture of particles. This was followed by melt compounding in a Leistritz extruder at barrel temperature ranging from 190 to 225° C. The melt compounding was followed by pelletization and drying, at 60° C. overnight in a vacuum oven. The dried pellets were melt processed on a single screw Killion extruder and blown into thin film at a barrel temperature of 390 F-375 F (199 to 191° C.) and a melt temperature of 400 F (204° C.) and die pressure of 1850 psi (13 MPa). The film samples obtained were: 0.06 to 0.09 mm in thickness. These film samples were evaluated by, ASTM D882 (Standard test method for Tensile properties). ASTM D 10003-00 (Standard test method for haze and luminous transmittance of transparent plastics) and ASTM E 313-00 (Standard practice for calculating yellowness and whiteness indices from instrumentally measured color coordinates). The films described below were evaluated for diffuse light transmission (Tt) and yellowness index (YI), Tt was measured in accordance with ASTM D 10003-00. Yellowness index values were determined by ASTM E 313-00. Both dynamic and static coefficient of friction were measured on a universal machine (Instron 5564) under the conditions and specifications of the ASTM 1894-06 test method. The melt index (MI), of the samples, were also quantified under ASTM D-1238. The data are given in TABLEs II, III and IV below.

### Example 12

Acrylic powder particles, C, of the composition given in TABLE I, were dry blended with XHS-7091 gas phase LLDPE resin (MI=1.00, Mw=119 k and density 0.9245) and AMPLIFY EA copolymer in the weight ratio (XHS-7091/C/AMPLIFY) of: 20; 70 and 10 all in weight percent to yield a finely dispersed powder plus granulated resin mixture of particles. This was followed by melt compounding in a Leistritz extruder at barrel temperature ranging from 190 to 225° C. The melt compounding was followed by pelletization and drying, at 60° C. overnight in a vacuum oven. The dried pellets were melt processed on a single screw Killion extruder and blown into thin film at a barrel temperature of 390 F-375 F (199 to 191° C.) and a melt temperature of 400 F (204° C.) and die pressure of 1850 psi (13 MPa). The film samples obtained were: 0.06 to 0.09 mm in thickness. These film samples were evaluated by, ASTM D882 (Standard test method for Tensile properties). ASTM D 10003-00 (Standard test method for haze and luminous transmittance of transparent plastics) and ASTM E 313-00 (Standard practice for calculating yellowness and whiteness indices from instrumentally measured color coordinates). The films described below were evaluated for diffuse light transmission (Tt) and yellowness index (YI), Tt was measured in accordance with ASTM D 10003-00. Yellowness index values were determined by ASTM E 313-00. Both dynamic and static coefficient of friction were measured on a universal machine (Instron 5564) under the conditions and specifications of the ASTM 1894-06 test method. The melt index (MI), of the samples, were also quantified under ASTM D-1238. The data are given in TABLEs II, III and IV below.

### Comparative Example 13

Huntsman Reyen polypropylene resin was melt processed in a Leistritz extruder at barrel temperature ranging from 200 to 224° C. The melt processing was followed by pelletization and drying, at 60° C. in a vacuum oven. After drying the pellets were injection molded at temperatures of 200-235° C. The test plates, derived from injection molding, were of the following dimension: 77 mm×56 mm×1.5 mm. The plates were evaluated by ASTM D 10003-00 (Standard test method for haze and luminous transmittance of transparent plastics) and ASTM E 313-00 (Standard practice for calculating yellowness and whiteness indices from instrumentally measured color coordinates). The data are listed in TABLE V.

### Examples 14-16

In the description that follows, sample D, of the compositions given in TABLE I, was dry blended with Huntsman Reyen polypropylene resin: Dry blends were prepared from mixtures of: 0.5, 1.0 and 1.5 weight percent of D, composition given in TABLE I. The dry blending step was followed by melt compounding in a Leistritz extruder at barrel temperature ranging from 200 to 235° C. The melt compounding was followed by pelletization and drying, at 60° C. in a vacuum oven. The test plates, derived from injection molding, were of the following dimension: 77 mm×56 mm×1.5 mm. The plates were evaluated by ASTM D 10003-00 (Standard test method for haze and luminous transmittance of transparent plastics) and ASTM E 313-00 (Standard practice for calculating yellowness and whiteness indices from instrumentally measured color coordinates). The data are listed in TABLE V.

### Examples 17-19

In the description that follows, sample E, of the compositions given in TABLE I, was dry blended with Huntsman Reyen polypropylene resin: Dry blends were prepared from mixtures of: 0.5, 1.0 and 1.5 weight percent of E, composition given in TABLE I. The dry blending step was followed by melt compounding in a Leistritz extruder at barrel temperature ranging from 200 to 235° C. The melt compounding was followed by pelletization and drying, at 60° C. in a vacuum oven. The test plates, derived from injection molding, were of the following dimension: 77 mm×56 mm×1.5 mm. The plates were evaluated by ASTM D 10003-00 (Standard test method for haze and luminous transmittance of transparent plastics) and ASTM E 313-00 (Standard practice for calculating yellowness and whiteness indices from instrumentally measured color coordinates). The data are listed in TABLE V.

### Example 20

The dried pellets (12.5 weight percent), of composition described in Example 4, were combined with DOWLEX 2045 resin (87.5 weight percent) to yield a blend of uniform composition. The pellet blend was melt processed on a single screw Killion extruder and blown into thin film at a barrel temperature of 390 F-375 F (199 to 191° C.) and a melt temperature of 400 F (204° C.) and die pressure of 1850 psi (13 MPa). The film samples obtained were: 0.06 mm in thickness. The film samples were evaluated by ASTM D 10003-00 (Standard test method for haze and luminous transmittance of transparent plastics) and ASTM E 313-00 (Standard practice for calculating yellowness and whiteness indices from instrumentally measured color coordinates). The films were also evaluated for diffuse light transmission (Tt) and yellowness index (YI), Tt was measured in accordance with ASTM D 10003-00. Yellowness index values were determined by ASTM E 313-00. The data are listed in TABLE VI.

### Example 21

The dried pellets (12.5 weight percent), of composition described in Example 5, were combined with DOWLEX 2045 resin (87.5 weight percent) to yield a blend of uniform composition. The pellet blend was melt processed on a single screw Killion extruder and blown into thin film at a barrel temperature of 390 F-375 F (199 to 191° C.) and a melt temperature of 400 F (204° C.) and die pressure of 1850 psi (13 MPa). The film samples obtained were: 0.03 mm in thickness. The film samples were evaluated by ASTM D 10003-00 (Standard test method for haze and luminous transmittance of transparent plastics) and ASTM E 313-00 (Standard practice for calculating yellowness and whiteness indices from instrumentally measured color coordinates). The films were also evaluated for diffuse light transmission (Tt) and yellowness index (YI), Tt was measured in accordance with ASTM D 10003-00. Yellowness index values were determined by ASTM E 313-00. The data are listed in TABLE VI.

### Example 22

The dried pellets (25.0 weight percent), of composition described in Example 6, were combined with DOWLEX 2045 resin (75.0 weight percent) to yield a blend of uniform composition. The pellet blend was melt processed on a single screw Killion extruder and blown into thin film at a barrel temperature of 390 F-375 F (199 to 191° C.) and a melt temperature of 400 F (204° C.) and die pressure of 1850 psi (13 MPa). The film samples obtained were: 0.04 mm in thickness. The film samples were evaluated by ASTM D 10003-00 (Standard test method for haze and luminous transmittance of transparent plastics) and ASTM E 313-00 (Standard practice for calculating yellowness and whiteness indices from instrumentally measured color coordinates). The films were also evaluated for diffuse light transmission (Tt) and yellowness index (YI), Tt was measured in accordance with ASTM D 10003-00. Yellowness index values were determined by ASTM E 313-00. The data are listed in TABLE VI.

### Example 23

The dried pellets (12.5 weight percent), of composition described in Example 7, were combined with DOWLEX 2027 resin (87.5 weight percent) to yield a blend of uniform composition. The pellet blend was melt processed on a single screw Killion extruder and blown into thin film at a barrel temperature of 390 F-375 F (199 to 191° C.) and a melt temperature of 400 F (204° C.) and die pressure of 1850 psi (13 MPa). The film samples obtained were: 0.04 mm in thickness. The film samples were evaluated by ASTM D 10003-00 (Standard test method for haze and luminous transmittance of transparent plastics) and ASTM E 313-00 (Standard practice for calculating yellowness and whiteness indices from instrumentally measured color coordinates). The films were also evaluated for diffuse light transmission (Tt) and yellowness index (YI), Tt was measured in accordance with ASTM D 10003-00. Yellowness index values were determined by ASTM E 313-00. The data are listed in TABLE VI.

### Example 24

The dried pellets (12.5 weight percent), of composition described in Example 8, were combined with DOWLEX 2027 resin (87.5 weight percent) to yield a blend of uniform composition. The pellet blend was melt processed on a single screw Killion extruder and blown into thin film at a barrel temperature of 390 F-375 F (199 to 191° C.) and a melt temperature of 400 F (204° C.) and die pressure of 1850 psi (13 MPa). The film samples obtained were: 0.04 mm in thickness. The film samples were evaluated by ASTM D 10003-00 (Standard test method for haze and luminous transmittance of transparent plastics) and ASTM E 313-00 (Standard practice for calculating yellowness and whiteness indices from instrumentally measured color coordinates). The films were also evaluated for diffuse light transmission (Tt) and yellowness index (YI), Tt was measured in accordance with ASTM D 10003-00. Yellowness index values were determined by ASTM E 313-00. The data are listed in TABLE VI.

### Example 25

The dried pellets (25 weight percent), of composition described in Example 9, were combined with DOWLEX 2027 resin (75 weight percent) to yield a blend of uniform composition. The pellet blend was melt processed on a single screw Killion extruder and blown into thin film at a barrel temperature of 390 F-375 F (199 to 191° C.) and a melt temperature of 400 F (204° C.) and die pressure of 1850 psi (13 MPa). The film samples obtained were: 0.04 mm in thickness. The film samples were evaluated by ASTM D 10003-00 (Standard test method for haze and luminous transmittance of transparent plastics) and ASTM E 313-00 (Standard practice for calculating yellowness and whiteness indices from instrumentally measured color coordinates). The films were also evaluated for diffuse light transmission (Tt) and yellowness index (YI), Tt was measured in accordance with ASTM D 10003-00. Yellowness index values were determined by ASTM E 313-00. The data are listed in TABLE VI.

### Example 26

The dried pellets (12.5 weight percent), of composition described in Example 10, were combined with XHS-7091 gas phase LLDPE resin (87.5 weight percent) to yield a blend of uniform composition. The pellet blend was melt processed on a single screw Killion extruder and blown into thin film at a barrel temperature of 390 F-375 F (199 to 191° C.) and a melt temperature of 400 F (204° C.) and die pressure of 1850 psi (13 MPa). The film samples obtained were: 0.03 mm in thickness. The film samples were evaluated by ASTM D 10003-00 (Standard test method for haze and luminous transmittance of transparent plastics) and ASTM E 313-00 (Standard practice for calculating yellowness and whiteness indices from instrumentally measured color coordinates). The films were also evaluated for diffuse light transmission (Tt) and yellowness index (YI), Tt was measured in accordance with ASTM D 10003-00. Yellowness index values were determined by ASTM E 313-00. The data are listed in TABLE VI.

### Example 27

The dried pellets (12.5 weight percent), of composition described in Example 11, were combined with XHS-7091 gas phase LLDPE resin (87.5 weight percent) to yield a blend of uniform composition. The pellet blend was melt processed on a single screw Killion extruder and blown into thin film at a barrel temperature of 390 F-375 F (199 to 191° C.) and a melt temperature of 400 F (204° C.) and die pressure of 1850 psi (13 MPa). The film samples obtained were: 0.04 mm in thickness. The film samples were evaluated by ASTM D 10003-00 (Standard test method for haze and luminous transmittance of transparent plastics) and ASTM E 313-00 (Standard practice for calculating yellowness and whiteness indices from instrumentally measured color coordinates). The films were also evaluated for diffuse light transmission (Tt) and yellowness index (YI), Tt was measured in accordance with ASTM D 10003-00. Yellowness index values were determined by ASTM E 313-00. The data are listed in TABLE VI.

### Example 28

The dried pellets (25 weight percent), of composition described in Example 12, were combined with XHS-7091 gas phase LLDPE resin (75 weight percent) to yield a blend of uniform composition. The pellet blend was melt processed on a single screw Killion extruder and blown into thin film at a barrel temperature of 390 F-375 F and a melt temperature of 400 F and die pressure of 1850 psi (13 MPa). The film samples obtained were: 0.04 mm in thickness. The film samples were evaluated by ASTM D 10003-00 (Standard test method for haze and luminous transmittance of transparent plastics) and ASTM E 313-00 (Standard practice for calculating yellowness and whiteness indices from instrumentally measured color coordinates). The films were also evaluated for diffuse light transmission (Tt) and yellowness index (YI), Tt was measured in accordance with ASTM D 10003-00. Yellowness index values were determined by ASTM E 313-00. The data are listed in TABLE VI.

TABLE I
Composition and particle size acrylic beads

| | | Particle |
|---|---|---|
| ID | Composition | Size, d₅₀ (μm) |
| A | 80% (BA/ALMA = 92/8)//20% (MMA/EA = 96/4) | 0.85 |
| B | 80% (BA/ALMA = 96/4)//20% MMA/EA = 96/4) | 5 |
| C | P (MMA/EA = 90/10) | 0.20 |
| D | 80% (BzA/ALMA = 96/4)//20% (MMA/EA = 96/4) | 0.88 |
| E | 80% (BzA/ALMA = 96/4)//20% (Styrene) | 0.75 |

TABLE II
Optical properties of films from the neat resins and blends

| | | | | | Y | YI D1925 |
|---|---|---|---|---|---|---|
| EX. | L | a | b | Haze | Total | (2/c) |
| Comp. 1 | 99.31 | 0.31 | −0.28 | 48.64 | 98.62 | −0.28 |
| Comp. 2 | 98.9 | 0.27 | −0.04 | 46.06 | 97.82 | 0.13 |
| Comp. 3 | 98.46 | 0.25 | 0.31 | 37.61 | 96.94 | 0.73 |
| 4 | 99.46 | 0.78 | 1.53 | 82.12 | 98.92 | 3.3 |
| 5 | 98.53 | 0.84 | 1.06 | 80.83 | 97.09 | 2.52 |
| 6 | 100.93 | 0.82 | 1.16 | 80.09 | 101.87 | 2.63 |
| 7 | 98.85 | 0.88 | 1.78 | 84.26 | 97.71 | 3.84 |
| 8 | 92.76 | 0.9 | 1.47 | 85.84 | 86.09 | 3.51 |
| 9 | 100.48 | 0.87 | 1.46 | 82.84 | 100.96 | 3.21 |
| 10 | 100.19 | 0.75 | 0.97 | 79.97 | 100.38 | 2.26 |
| 11 | 91.54 | 0.85 | 1.72 | 86.34 | 83.8 | 4.01 |
| 12 | 100.47 | 0.77 | 1.13 | 75.85 | 100.94 | 2.55 |

TABLE III
Mechanical properties of films from the neat resins and blends

| | | | Stress @ | Yield | Stress at | Break | |
|---|---|---|---|---|---|---|---|
| | Thickness | Modulus | 100% | Stress | Max | Elongation | Toughness |
| EX. | (in) | (psi) | (psi) | (psi) | (psi) | (%) | (in-lb/in³) |
| Comp. 1 | 0.0024 | 10222 | 1380.8 | 1122 | 5490 | 783.6 | 19054 |
| Comp. 2 | 0.000967 | 5228.333 | 2123 | 2576.833 | 3785 | 1255.667 | 34585 |
| Comp. 3 | 0.00112 | 10528 | 1940.2 | 1820 | 5172 | 740 | 19482 |
| 4 | 0.00346 | 8788 | 996.8 | 499.2 | 1556.2 | 684.6 | 7520 |
| 5 | 0.00296 | 7902 | 953.8 | 605 | 1597.6 | 565 | 6186 |
| 6 | 0.00394 | 13834 | 1002.8 | 954.4 | 2067.8 | 769.6 | 9730 |
| 7 | 0.00328 | 4692.1 | 0 | 482.91 | 1541.8 | 62.84 | 706.4 |
| 8 | 0.00238 | 5268 | 0 | 1142.8 | 1508.2 | 41.46 | 418.4 |
| 9 | 0.00358 | 21290.4 | 1213 | 1605.4 | 2083.8 | 658.12 | 10665.2 |
| 10 | 0.005075 | 8312.5 | 1095.5 | 835.75 | 1712.75 | 701.5 | 8535 |
| 11 | 0.00542 | 5406 | 847.8 | 758.4 | 1163.2 | 564.6 | 5130 |
| 12 | 0.00346 | 9214 | 912.2 | 878.2 | 2304 | 742.8 | 9404 |

TABLE IV
Melt Index (MI) of neat resins and blends and surface properties of films
from the same

| EX. | MI | Static | Dynamic | Load lbf |
|---|---|---|---|---|
| Comp. 1 | 1.005 | 0.461 | 0.503 | 0.241 |
| Comp. 2 | 4 | 0.358 | 0.344 | 0.167 |
| Comp. 3 | 1.03 | 0.074 | 0.119 | 0.077 |
| 4 | 0.38525 | 0.175 | 0.155 | 0.078 |
| 5 | 0.3105 | 0.13 | 0.123 | 0.064 |
| 6 | 0.796 | 0.102 | 0.095 | 0.048 |
| 7 | 1.24325 | 0.134 | 0.12 | 0.06 |
| 8 | 1.01025 | 0.123 | 0.108 | 0.056 |
| 9 | 2.9185 | 0.105 | 0.096 | 0.049 |
| 10 | 3.788 | 0.161 | 0.127 | 0.071 |
| 11 | 2.376 | 0.106 | 0.104 | 0.054 |
| 12 | 6.954 | 0.172 | 0.106 | 0.076 |

TABLE V
Optical properties of neat polypropylene
resin and blends with polymer particles

| | | | | | YI | | 457 |
|---|---|---|---|---|---|---|---|
| | | | | | D1925 | | Bright- |
| EX. | L | a | b | Haze | (2/C) | Y Total | ness |
| Comp. | 96.74 | 0.22 | 2.17 | 62.30 | 4.17 | 93.59 | 90.69 |
| 13 | | | | | | | |
| 14 | 96.72 | 0.04 | 2.98 | 74.48 | 5.53 | 93.54 | 89.59 |
| 15 | 95.25 | −0.14 | 5.01 | 81.67 | 9.29 | 90.72 | 84.19 |
| 16 | 93.54 | −0.06 | 5.86 | 84.00 | 11.14 | 87.50 | 79.98 |
| 17 | 96.34 | 0.11 | 3.86 | 81.94 | 7.24 | 92.81 | 87.71 |
| 18 | 93.26 | 0.14 | 5.64 | 85.26 | 10.91 | 86.98 | 79.77 |
| 19 | 90.67 | 0.20 | 6.27 | 86.05 | 12.51 | 82.22 | 74.42 |

TABLE VI
Optical properties of neat polypropylene
resin and blends with polymer particles

| | | | | | | | YI |
|---|---|---|---|---|---|---|---|
| Exam- | | | | | Y | Y | D1925 |
| ples | L | a | b | Haze | Total | Diffuse | (2/C) |
| 20 | 98.83 | 0.42 | 0.29 | 55.01 | 97.67 | 53.73 | 0.83 |
| 21 | 98.75 | 0.51 | 0.71 | 54.53 | 97.51 | 53.17 | 1.65 |
| 22 | 97.87 | 0.4 | 0.53 | 45.75 | 95.79 | 43.82 | 1.26 |
| 23 | 98.75 | 0.33 | 0.1 | 46.45 | 97.51 | 45.29 | 0.42 |
| 24 | 98.86 | 0.71 | 0.74 | 69.6 | 97.73 | 68.02 | 1.84 |
| 25 | 98.58 | 0.41 | 0.47 | 49.3 | 97.17 | 47.91 | 1.16 |
| 26 | 99.39 | 0.56 | 0.51 | 64.86 | 98.78 | 64.07 | 1.32 |
| 27 | 98.55 | 0.53 | 0.7 | 56.48 | 97.12 | 54.85 | 1.66 |
| 28 | 98.37 | 0.49 | 0.75 | 50.68 | 96.78 | 49.05 | 1.71 |

### Example 29

### Pre-Seed Polymer

This example illustrates the preparation of crosslinked polymer pre-seeds of 0.25 μm in diameter for making large seed particles in aqueous dispersion. The following mixtures A-C were prepared with deionized water:

| Mixture | Component | Parts by Weight |
|---|---|---|
| A1 | Water | 180 |
| | Sodium Carbonate | 0.40 |
| B1 | n-Butyl Acrylate | 98.0 |
| | Allyl Methacrylate | 1.75 |
| | 1,4-Butanediol Diacrylate | 0.25 |
| | 22.5% aqueous Sodium | 2.22 |
| | Dodecylbenzenesulfonate | |
| | Water | 40.8 |
| C1 | Sodium Persulfate | 0.06 |
| | Water | 11.9 |

A reactor equipped with stirrer and condenser and blanked with nitrogen was charged with Mixture A1 and heated to 83° C. To the reactor contents was added 10% of emulsified Mixture B1 and 25% of Mixture C1. The temperature was maintained at 83° C. and the mixture was stirred for 60 minutes, after which the remaining Mixture B1 and Mixture C1 were added to the reactor with stirring over a period of 120 minutes. Stirring was continued at 83° C. for 90 minutes, after which the reactor contents were cooled to room temperature. The particle size of the resulting particle pre-seeds was 0.25 μm as measured by a Brookhaven Instruments particle size analyzer BI-90.

### Example 30

### Polymer Seeds

In this example the pre-seed particles in the emulsion of Example 13 are grown to 0.56 μm diameter using n-butyl acrylate, styrene, and 1-hexanethiol. The following mixtures A2-G2 were prepared with deionized water:

| | | Parts |
|---|---|---|
| Mixture | Component | by Weight |
| A2 | Sodium Carbonate | 0.08 |
| | 9.76% aqueous Sodium Dodecylbenzenesulfonate | 0.01 |
| | Water | 156.00 |
| B2 | 30.10% aqueous emulsion from Example 1 | 29.80 |
| C2 | n-Butyl Acrylate | 81.80 |
| | Styrene | 18.20 |
| | 9.76% aqueous Sodium Dodecylbenzenesulfonate | 4.53 |
| | Water | 57.50 |
| D2 | 1-Hexanethiol/n-DDM | 18.80 |
| | 9.76% aqueous Sodium Dodecylbenzenesulfonate | 0.58 |
| | Water | 15.00 |
| E2 | Sodium Persulfate | 0.11 |
| | Water | 47.40 |
| F2 | t-Butyl Hydroperoxide 70% | 0.30 |
| | Water | 15.00 |
| G2 | Sodium Formaldehyde Sulfoxylate | 0.20 |
| | Water | 6.67 |

Mixture A2 was added to the reactor of Example 13 and heated to 88° C. with stirring. The air in the reactor was replaced by nitrogen. When the reactor temperature stabilized at 88° C., Mixture B2 was charged into the reactor. Emulsified Mixtures C2 and D2, and Mixture E2 were then added to the reactor, with stirring, over a period of 300 minutes. Stirring was continued at 88° C. for 90 minutes. The reactor contents were cooled to 65° C. Mixtures F2 and G2 were added and the reactor contents were maintained at 65° C. with stirring for 1 hour, after which the reactor contents were cooled to room temperature. The resulting emulsion particles had a diameter of 0.56 μm as measured by a Brookhaven Instruments particle size analyzer BI-90.

### Example 31

### GRIN Sphere Composition

In this example, the particles in the emulsion of Example 14 are expanded to create 5 μm diameter divergent lenses using n-butyl acrylate and ally methacrylate in Stage I which is then followed by Stage II copolymerization of methyl methacrylate and ethyl acrylate. The following mixtures A3-G3 were prepared with deionized water:

| | | |
|---|---|---|
| | | Parts |
| Mixture | Component | by Weight |

Stage I

| | | |
|---|---|---|
| A3 | Water | 138.50 |
| B3 | | |
| | Aqueous emulsion from Example 2 at 29.88% solids | 0.105 |
| C3 | n-Butyl Acrylate | 76.80 |
| | Allyl Methacrylate | 3.20 |
| | 10% aqueous Sodium Dodecylbenzenesulfonate | 0.28 |
| | Water | 33.12 |
| D3 | t-Butyl Peroctoate | 0.427 |
| | 10% aqueous Sodium Dodecylbenzenesulfonate | 0.003 |
| | Water | 2.96 |

Stage II

| | | |
|---|---|---|
| E3 | Methyl Methacrylate | 19.20 |
| | Ethyl Acrylate | 0.80 |
| F3 | Sodium Formaldehyde Sulfoxylate | 0.062 |
| | Water | 6.67 |
| | 10% aqueous Sodium Dodecylbenzenesulfonate | 0.017 |
| G3 | t-Butyl Hydroperoxide 70% | 0.089 |
| | Water | 10.05 |
| | 10% aqueous Sodium Dodecylbenzenesulfonate | 0.037 |

To the reactor of Example 15 was added A3 which was heated to 90° C. with stirring. The air in the reactor was replaced by nitrogen. When the reactor temperature stabilized at 90° C., Mixture B3 was charged into the reactor. Mixture C3 was emulsified with a homogenizer and charged into the reactor. The reactor was stirred at 60° C. for 1 hour. Mixture D3 was emulsified with a homogenizer and charged into the reactor. After 1 hour agitation at 60° C., the reactor was gradually heated to 65-70° C. while an exothermic polymerization takes place. After reach peak temperature, agitation was continued while the reactor was cooled to 73° C. in 30 minutes. Charge half of Mixture F3. Mixtures E3, the remainder of F3, and G3 were then separately added into the reactor over a period of 2 hours. The temperature was maintained between 73-75° C. and stirring was continued for 1 hour before the reactor was cooled to room temperature. The resulting emulsion particles, had a diameter of 5 μm as measured by a Coulter Corporation Multisizer IIE particle size analyzer.

### Example 32

This example illustrates the preparation of crosslinked polymer particles of 0.045 μm in diameter for making large seed particles in aqueous dispersion. The following mixtures were prepared with deionized water:

| Mixture | Component | Parts by Weight |
|---|---|---|
| A | Water | 180 |
| | Sodium Carbonate | 0.40 |
| B | n-Butyl Acrylate | 99.3 |
| | Allyl Methacrylate | 0.70 |
| | 1,4-Butanediol Diacrylate | 0.25 |
| | 22.5% aqueous Sodium | 2.22 |
| | Dodecylbenzenesulfonate | |
| | Water | 40.8 |
| C | Sodium Persulfate | 0.06 |
| | Water | 11.9 |

A reactor equipped with stirrer and condenser and blanked with nitrogen was charged with Mixture A and heated to 83° C. To the reactor contents was added 10% of emulsified Mixture B and 25% of Mixture C. The temperature was maintained at 83° C. and the mixture was stirred for 60 minutes, after which the remaining Mixture B and Mixture C were added to the reactor with stirring over a period of 120 minutes. Stirring was continued at 83° C. for 90 minutes, after which the reactor contents were cooled to room temperature. The particle size and solid content of the resulting emulsion was 0.054 μm and 32.52% respectively The particle size was measured by a Brookhaven Instruments particle size analyzer BI-90.

### Example 33

In this example the particles in the emulsion of Example 1 are grown to 0.21 μm diameter using n-butyl acrylate, styrene, and 1-hexanethiol. The following mixtures were prepared with deionized water:

| | | Parts |
|---|---|---|
| Mixture | Component | by Weight |
| A | Sodium Carbonate | 0.08 |
| | 9.76% aqueous Sodium Dodecylbenzenesulfonate | 0.01 |
| | Water | 156.00 |
| B | 30.10% aqueous emulsion from Example 1 | 29.80 |
| C | n-Butyl Acrylate | 81.80 |
| | Styrene | 18.20 |
| | 9.76% aqueous Sodium Dodecylbenzenesulfonate | 4.53 |
| | Water | 57.50 |
| D | 1-Hexanethiol/n-DDM | 18.80 |
| | 9.76% aqueous Sodium Dodecylbenzenesulfonate | 0.58 |
| | Water | 15.00 |
| E | Sodium Persulfate | 0.11 |
| | Water | 47.40 |
| F | t-Butyl Hydroperoxide 70% | 0.30 |
| | Water | 15.00 |
| G | Sodium Formaldehyde Sulfoxylate | 0.20 |
| | Water | 6.67 |

Mixture A was added to the reactor of Example 1 and heated to 88° C. with stirring. The air in the reactor was replaced by nitrogen. When the reactor temperature stabilized at 88° C., Mixture B was charged into the reactor. Emulsified Mixtures C and D, and Mixture E were then added to the reactor, with stirring, over a period of 300 minutes. Stirring was continued at 88° C. for 90 minutes. The reactor contents were cooled to 65° C. Mixtures F and G were added and the reactor contents were maintained at 65° C. with stirring for 1 hour, after which the reactor contents were cooled to room temperature. The resulting emulsion particles had a diameter of 0.21 μm as measured by a Brookhaven Instruments particle size analyzer BI-90.

### Example 34

In this example, the particles in the emulsion of Example 2 are expanded to create 0.84 μm diameter divergent lenses using n-butyl acrylate and ally methacrylate in Stage I which is then followed by Stage II copolymerization of methyl methacrylate and ethyl acrylate. The following mixtures A3-G3 were prepared with deionized water:

| | | |
|---|---|---|
| | | Parts |
| Mixture | Component | by Weight |

Stage I

| | | |
|---|---|---|
| A3 | Water | 138.50 |
| B3 | | |
| | Aqueous emulsion from Example 2 at 29.88% solids | 0.105 |
| C3 | n-Butyl Acrylate | 76.80 |
| | Allyl Methacrylate | 3.20 |
| | 10% aqueous Sodium Dodecylbenzenesulfonate | 0.28 |
| | Water | 33.12 |
| D3 | t-Butyl Peroctoate | 0.427 |
| | 10% aqueous Sodium Dodecylbenzenesulfonate | 0.003 |
| | Water | 2.96 |

Stage II

| | | |
|---|---|---|
| E3 | Methyl Methacrylate | 19.20 |
| | Ethyl Acrylate | 0.80 |
| F3 | Sodium Formaldehyde Sulfoxylate | 0.062 |
| | Water | 6.67 |
| | 10% aqueous Sodium Dodecylbenzenesulfonate | 0.017 |
| G3 | t-Butyl Hydroperoxide 70% | 0.089 |
| | Water | 10.05 |
| | 10% aqueous Sodium Dodecylbenzenesulfonate | 0.037 |

To the reactor of Example 2 was added A3 which was heated to 90° C. with stirring. The air in the reactor was replaced by nitrogen. When the reactor temperature stabilized at 90° C., Mixture B3 was charged into the reactor. Mixture C3 was emulsified with a homogenizer and charged into the reactor. The reactor was stirred at 60° C. for 1 hour. Mixture D3 was emulsified with a homogenizer and charged into the reactor. After 1 hour agitation at 60° C., the reactor was gradually heated to 65-70° C. while an exothermic polymerization takes place. After reach peak temperature, agitation was continued while the reactor was cooled to 73° C. in 30 minutes. Charge half of Mixture F3. Mixtures E3, the remainder of F3, and G3 were then separately added into the reactor over a period of 2 hours. The temperature was maintained between 73-75° C. and stirring was continued for 1 hour before the reactor was cooled to room temperature. The resulting emulsion particles, had a diameter of 0.84 μm as measured by a Coulter Corporation Multisizer IIE particle size analyzer.

1. A film comprising from 1 to 50 wt % of polymeric particles having: (a) an average particle diameter from 0.5 to 15 μm; (b) a refractive index from 1.46 to 1.7; and (c) at least 60% polymerized residues of acrylic monomers; and a continuous polymeric phase comprising a polyolefin; wherein an average refractive index difference measured from 400 nm to 800 nm between the polymeric particles and the continuous polymeric phase is at least 0.03.

2. The film of claim 1 in which the polymeric particles have a refractive index from 1.52 to 1.65.

3. The film of claim 2 in which the polyolefin comprises polymers or copolymers of alkenes having from two to eight carbon atoms.

4. The film of claim 3 in which the polymeric particles comprise at least 70% polymerized residues of acrylic and styrenic monomers

5. The film of claim 4 in which the continuous polymeric phase comprises from 2 to 20 wt % of the polymeric particles.

6. The film of claim 5 in which the average particle diameter is from 0.7 to 8 μm.

7. The film of claim 6 in which the polymeric particles have a refractive index from 1.53 to 1.65.

8. The film of claim 7 in which the refractive index at the center of the polymeric particles is from 1.46 to 1.52 and the refractive index at the surface is from. 1.53 to 1.65.

9. The film of claim 8 in which the continuous polymeric phase is polyethylene or polypropylene.

10. The film of claim 9 in which the polyethylene or polypropylene comprises from 3 to 15 wt % of the polymeric particles.
